(19) United States
(12) Patent Application Publication
(10) Pub. No.: US 2015/0168621 A1
(43) Pub. Date: Jun. 18, 2015

(54) WAVELENGTH SELECTION COLOR FILTER AND DISPLAY STRUCTURE USING SAME

(71) Applicant: SHENZHEN CHINA STAR OPTOELECTRONICS TECHNOLOGY CO., LTD., Shenzhen, Guangdong (CN)

(72) Inventor: Hongji Huang, Shenzhen City (CN)

(21) Appl. No.: 14/241,057

(22) PCT Filed: Dec. 31, 2013
(86) PCT No.: PCT/CN2013/091256

§ 371 Date: Feb. 25, 2014

(30) Foreign Application Priority Data
Dec. 18, 2013 (CN) 201310700201.8

(51) Int. Cl. G02B 5/28

(52) U.S. Cl. CPC G02B 5/288

(57) ABSTRACT

The present invention provides a wavelength selection color filter and a display structure using the wavelength selection color filter. The wavelength selection color filter includes: a first high-reflectivity material layer, a first dielectric material layer formed on the first high-reflectivity material layer, and a second high-reflectivity material layer formed on the first dielectric material layer. The first and second high-reflectivity material layers define therebetween at least two fixed spacing distance. By using the wavelength selection characteristic of a Fabry-Perot structure, light filtering is done in a reflective way of light filtering so as to enhance color saturation of the light obtained and improve utilization of light. The wavelength selection color filter of the display structure of the present invention can be simultaneously integrated with a TFT array structure layer on a common substrate so as to reduce the influence of alignment preciseness and to increase aperture ratio of the display panel to thereby achieve high transmissivity of the display panel.

### BACKGROUND OF THE INVENTION

1. Field of the Invention

The present invention relates to the field of flat panel displaying, and in particular to a wavelength selection color filter and a display structure using the wavelength selection color filter.

2. The Related Arts

Flat panel displays include liquid crystal displays (LCDs) and organic light emitting diode (OLED) displays, which have a variety of advantages, such as thin device body, low power consumption, and being free of radiation, and are thus of wide applications.

Referring to FIG. 1, a display structure of a conventional liquid crystal display generally comprises: a TFT (Thin-Film Transistor) substrate 100, a CF (Color Filter) substrate 300 laminated to the TFT substrate 100, and liquid crystal 500 interposed between the TFT substrate 100 and the CF substrate 300. The TFT substrate 100 generally comprises: a substrate 102 and a TFT array 104 formed on the substrate 102. The TFT array 104 is formed on the substrate 102 through a masking process. Referring to FIG. 2, the CF substrate 300 comprises: a substrate 302 and RGB (Red, Green, and Blue) color photoresists 304 and a BM (Black Matrix) 306 formed on the substrate 302.

The CF substrate 300 makes selective light filtering by taking advantage of the absorbability of different color photoresists 304 with respect to lights of specific wavelengths. Consequently, such an absorptive CF substrate 300 has a transmittance loss of around ⅔ so that the utilization of light is low and color saturation is poor. Further, since the TFT array and CF are respectively formed on two different substrates first and are then aligned and combined to form a display structure, there is a constraint posed on the preciseness of alignment thereby affecting the aperture ratio and utilization of light.

A Fabry-Perot structure is a cavity structure that is formed of two parallel-arranged high-reflectivity film materials, wherein an input light gets perpendicular incident to the first film material and light passing through the cavity and exiting the second film material becomes an output light. The formula of FP cavity transmission function can be used to exhibit the characteristics of transmissivity variation of an FP cavity with respect to wavelength. The transmission function of FP cavity is as follows:

$$T ( \vert λ ) = 20 log ( \frac{{( 1 - \frac{A}{1 - R} )}^{2}}{{( 1 + ( \frac{2 \sqrt{R}}{1 - R} sin ( 2 {π}_{n} ( {l}_{0} + Δ l ) / λ ) ) )}^{2}} )$$

In the formula, A indicates the absorptivity of the film material and an inside-cavity material; R is reflectivity of the film material; n is the refractive index of the inside-cavity material; I₀ is cavity length; Δ/ is variation of cavity length; A is wavelength of light; and T(|λ) is characteristics of transmissivity variation of the FP cavity with respect to wavelength. It is known from the above formula that the transmissivity of the FP cavity is related to the wavelength of light. The Fabry-Perot structure can be used to select lights of different wavelengths by using the property of interference of light. Such a selection is a reflective way (not an absorptive way) so that the utilization of light is high. Further, color saturation of light after selection made with the Fabry-Perot structure is also better.

Application of the Fabry-Perot structure to a color filter would well improve color saturation of the light subjected to filtering by the color filter and also increase utilization of light and also enable the color filter to be simultaneously integrated with a TFT array on the same substrate.

### SUMMARY OF THE INVENTION

An object of the present invention is to provide a wavelength selection color filter, which takes advantage of the wavelength selection characteristic of a Fabry-Perot Structure to achieve a reflective way (not an absorptive way) of light filtering so as to enhance the utilization of light.

Another object of the present invention is to provide a display structure, which comprises a Fabry-Perot structure based wavelength selection color filter to enable simultaneous integration of the color selection color filter with a thin-film transistor (TFT) array on a common substrate.

To achieve the above objects, the present invention provides a wavelength selection color filter, which comprises: a first high-reflectivity material layer, a first dielectric material layer formed on the first high-reflectivity material layer, and a second high-reflectivity material layer formed on the first dielectric material layer. The first and second high-reflectivity material layers define therebetween at least two fixed spacing distances.

The first and second high-reflectivity material layers are metal material layers, non-metallic material layers, or composite material layers and the first and second high-reflectivity material layers are single-layered structures or multiple-layered structures; and the first dielectric material layer is a metal compound layer, an organic material layer, or a composite material layer and the first dielectric material layer is a single-layered structure.

The first and second high-reflectivity material layers are single-layered silver films; and the first dielectric material layer is a single-layered silicon dioxide film.

The single-layered silver films have a thickness of 20 nm and the first and second high-reflectivity material layers define therebetween three fixed spacing distances that are respectively 200 nm, 345 nm, 290 nm.

The present invention also provides a wavelength selection color filter, which comprises: a first high-reflectivity material layer, a first dielectric material layer formed on the first high-reflectivity material layer, and a second high-reflectivity material layer formed on the first dielectric material layer, the first and second high-reflectivity material layers defining therebetween at least two fixed spacing distances;

wherein the first and second high-reflectivity material layers are metal material layers, non-metallic material layers, or composite material layers and the first and second high-reflectivity material layers are single-layered structures or multiple-layered structures; and the first dielectric material layer is a metal compound layer, an organic material layer, or a composite material layer and the first dielectric material layer is a single-layered structure.

The first and second high-reflectivity material layers are single-layered silver films; and the first dielectric material layer is a single-layered silicon dioxide film.

The single-layered silver films have a thickness of 20 nm and the first and second high-reflectivity material layers define therebetween three fixed spacing distances that are respectively 200 nm, 345 nm, 290 nm.

The present invention further provides a display structure, which comprises: a substrate, a wavelength selection color filter formed on the substrate, a planarization layer formed on the wavelength selection color filter, and a TFT array structure layer formed on the planarization layer. The wavelength selection color filter comprises: a first high-reflectivity material layer, a first dielectric material layer formed on the first high-reflectivity material layer, and a second high-reflectivity material layer formed on the first dielectric material layer. The first and second high-reflectivity material layers define therebetween at least two fixed spacing distances.

The substrate is a glass substrate or a transparent plastic substrate; the planarization layer is a dielectric material layer; and the TFT array structure layer is formed on the planarization layer through processes of film formation, exposure, development, and etching.

The first and second high-reflectivity material layers are metal material layers, non-metallic material layers, or composite material layers and the first and second high-reflectivity material layers are single-layered structures or multiple-layered structures; and the first dielectric material layer is a metal compound layer, an organic material layer, or a composite material layer and the first dielectric material layer is a single-layered structure.

The first and second high-reflectivity material layers are single-layered silver films; and the first dielectric material layer is a single-layered silicon dioxide film.

The single-layered silver films have a thickness of 20 nm and the first and second high-reflectivity material layers define therebetween three fixed spacing distances that are respectively 200 nm, 345 nm, 290 nm.

The display structure further comprises a white-light organic electroluminescence structure layer formed on the TFT array structure layer.

The efficacy of the present invention is that the present invention provides a wavelength selection color filter, which uses the wavelength selection characteristic of a Fabry-Perot structure to achieve a reflective way (not an absorptive way) of light filtering so as to enhance color saturation of the light obtained and improve utilization of light. The display structure of the present invention uses the wavelength selection color filter that includes a Fabry-Perot structure to enhance color saturation of the obtain light and improve the utilization of light, and also enable simultaneous integration of the wavelength selection color filter with a TFT array structure layer on a common substrate, so as to reduce the influence of alignment preciseness and to increase aperture ratio of the display panel to thereby achieve high transmissivity of the display panel.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing the structure of a conventional liquid crystal display structure;

FIG. 2 is a schematic view showing the structure of a conventional color filter substrate;

FIG. 3 is a schematic view showing the structure of a wavelength selection color filter according to a preferred embodiment of the present invention;

FIG. 4 is a schematic view showing a display structure according to a first embodiment of the present invention; and

FIG. 5 is a schematic view showing a display structure according to a second embodiment of the present invention.

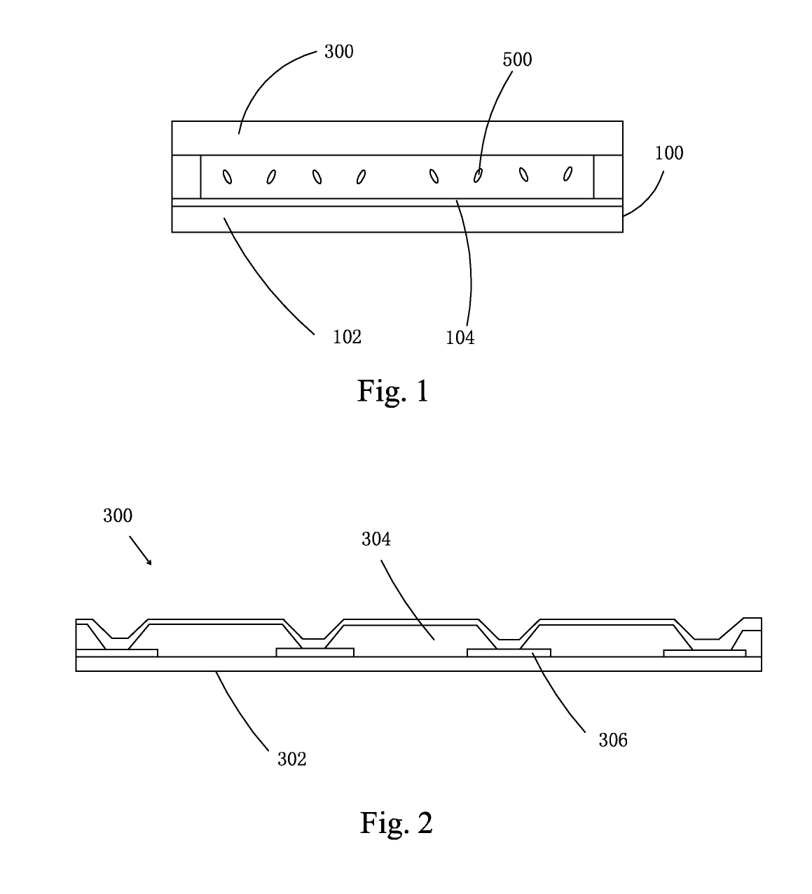

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

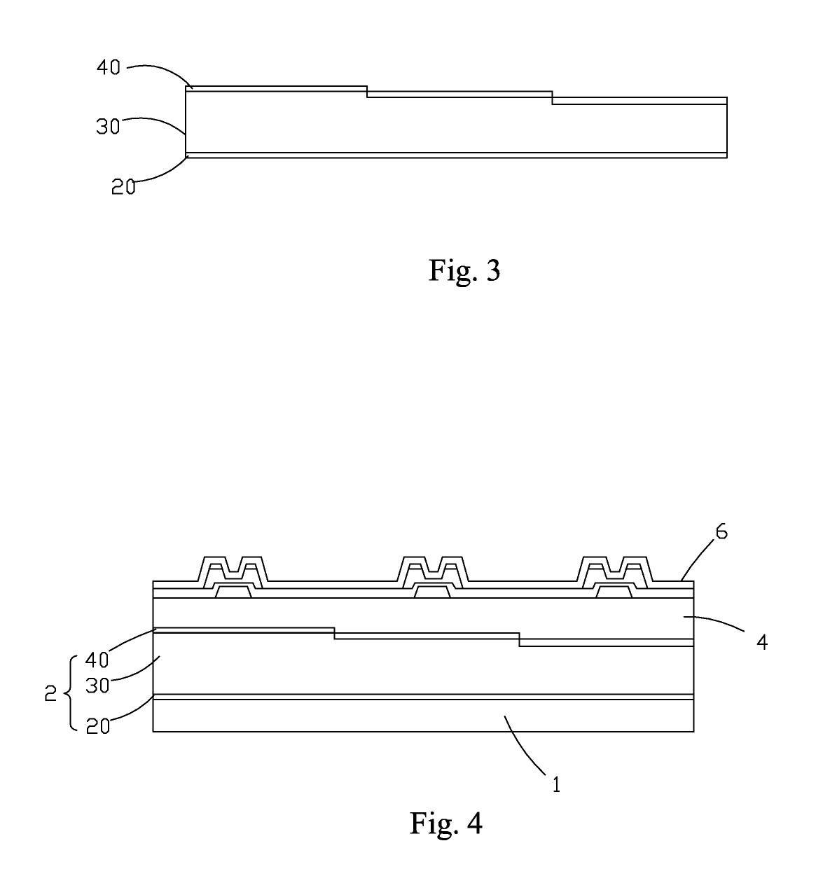

Referring to FIG. 3, which is a schematic view showing a wavelength selection color filter according to a preferred embodiment of the present invention, the wavelength selection color filter comprises: a first high-reflectivity material layer 20, a first dielectric material layer 30 formed on the first high-reflectivity material layer 20, and a second high-reflectivity material layer 40 formed on the first dielectric material layer 30. The first and second high-reflectivity material layers 20, 40 define therebetween at least two fixed spacing distances, meaning the first dielectric material layer 30 has at least two thicknesses.

It can be seen that the wavelength selection color filter has a structure comprising multiple layers of parallel planar surfaces, which when combined with the materials used thereby, can be considered as a Fabry-Perot structure. An input light gets incident perpendicularly to the first high-reflectivity material layer 20, passes through the first dielectric material layer 30, and exits the second high-reflectivity material layer 40 as an output light. The formula of transmission function of an FP cavity can be used to describe the light transmissivity of the wavelength selection color filter according to the present invention. The formula of transmission function of FP cavity is as follows:

$$T ( \vert λ ) = 20 log ( \frac{{( 1 - \frac{A}{1 - R} )}^{2}}{{( 1 + ( \frac{2 \sqrt{R}}{1 - R} sin ( 2 {π}_{n} ( {l}_{0} + Δ l ) / λ ) ) )}^{2}} ) .$$

In the above formula, by comparing with the arrangement of an FP cavity of a known Fabry-Perot structure, in the application of the present invention, A is the absorptivity of the first and second high-reflectivity material layers 20, 40 and the first dielectric material layer 30; R is the reflectivity of the first and second high-reflectivity material layers 20, 40; n is the refractive index of the first dielectric material layer 30; I₀ is the thickness of the first dielectric material layer 30, Δ/ is the difference between different fixed spacing distances between the first and second high-reflectivity material layers 20, 40, λ is the wavelength of light, T(|λ) is the characteristic of light transmissivity variation of the wavelength selection color filter according to the present invention with respect to the wavelength.

It is known from the formula, the materials of the first and second high-reflectivity material layers 20, 40 and the first dielectric material layer 30 and the thicknesses of the first dielectric material layer 30 (the fixed spacing distances between the first and second high-reflectivity material layers 20, 40) collectively determine the light transmissivity of the wavelength selection color filter with respect to wavelength. Thus, through individually varying the material of the first and second high-reflectivity material layers 20, 40 or the first dielectric material layer 30 or individually adjusting the thickness of the first dielectric material layer 30 or through simultaneously changing the materials of the first and second high-reflectivity material layers 20, 40 and the first dielectric material layer 30 and the thicknesses of the first dielectric material layer 30, selectivity of wavelength of the transmitting light can be achieved.

The first and second high-reflectivity material layers 20, 40 can be metal material layers, non-metallic material layers, or composite material layers, and can be single-layered structures or multiple-layered structures. The first and second high-reflectivity material layers 20, 40 may have reflectivity greater than 50% but less than 100% in the visible light range of wavelength 380 nm to 780 nm.

In the instant embodiment, the first and second high-reflectivity material layers 20, 40 are both single-layered silver films.

The first dielectric material layer 30 can be a metal compound layer, an organic material layer, or a composite material layer, and is generally a single layer. The first dielectric material layer 30 has a refractive index between 1.3 and 2.1 in the visible light range of wavelength 380 nm to 780 nm.

In the instant embodiment, the first dielectric material layer 30 is a single-layered silicon dioxide (SiO₂) film.

Since there are at least two fixed spacing distances between the first and second high-reflectivity material layers 20, 40, thicknesses are defined at different locations of the first dielectric material layer 30 can be defined to respectively correspond to lights of different wavelengths.

In the instant embodiment, the first and second high-reflectivity material layers 20, 40 are each formed of a single-layered silver film having a thickness of 20 nm, between which three fixed spacing distances, which are respectively 200 nm, 345 nm, and 290 nm. In other words, the thicknesses of the first dielectric material layer 30, which is a single-layered silicon dioxide film, at the locations respectively corresponding to the three fixed spacing distances are respectively 200 nm, 345 nm, and 290 nm, which correspond, in sequence, to the wavelengths of blue (426 nm), green (537 nm), and red (618 nm). According to the above formula, a wavelength selection color filter having an average transmissivity greater than 50% for full band can be obtained.

In a practical application, the wavelength selection color filter can achieve high efficiency selection of specific wavelength having a FWHM (Full Width at Half Maximum) less than 30 nm and light transmissivity close to 100% by adjusting the reflectivity of the first and second high-reflectivity material layers 20, 40 and the thickness of the first dielectric material layer 30, whereby high color saturation can be realized and thus utilization of light can be greatly enhanced.

Referring to FIG. 4, which is a schematic view showing a display structure according to a first embodiment of the present invention that uses the wavelength selection color filter, the display structure comprises: a substrate 1, a the wavelength selection color filter 2 formed on the substrate 1, a planarization layer 4 formed on the wavelength selection color filter 2, and a TFT array structure layer 6 formed on the planarization layer 4; the wavelength selection color filter 2 comprises: a first high-reflectivity material layer 20, a first dielectric material layer 30 formed on the first high-reflectivity material layer 20, and a second high-reflectivity material layer 40 formed on the first dielectric material layer 30. The first and second high-reflectivity material layers 20, 40 define therebetween at least two fixed spacing distances, meaning the first dielectric material layer 30 has at least two thicknesses.

The substrate 1 is a glass substrate or a transparent plastic substrate.

The first and second high-reflectivity material layers 20, 40 can be metal material layers, non-metallic material layers, or composite material layers and be single-layered structures or multiple-layered structures. The first and second high-reflectivity material layers 20, 40 may have reflectivity greater than 50% but less than 100% in the visible light range of wavelength 380 nm to 780 nm.

In the instant embodiment, the first and second high-reflectivity material layers 20, 40 are both single-layered silver films.

The first dielectric material layer 30 can be a metal compound layer, an organic material layer, or a composite material layer, and is generally a single layer. The first dielectric material layer 30 has a refractive index between 1.3 and 2.1 in the visible light range of wavelength 380 nm to 780 nm.

In the instant embodiment, the first dielectric material layer 30 is a single-layered silicon dioxide (SiO₂) film.

Since there are at least two fixed spacing distances between the first and second high-reflectivity material layers 20, 40, thicknesses are defined at different locations of the first dielectric material layer 30 can be defined to respectively correspond to lights of different wavelengths.

Specifically, the materials of the first and second high-reflectivity material layers 20, 40 and the first dielectric material layer 30 and the thicknesses of the first dielectric material layer 30 (the fixed spacing distances between the first and second high-reflectivity material layers 20, 40) collectively determine the light transmissivity of the wavelength selection color filter with respect to wavelength. Thus, through individually varying the material of the first and second high-reflectivity material layers 20, 40 or the first dielectric material layer 30 or individually adjusting the thickness of the first dielectric material layer 30 or through simultaneously changing the materials of the first and second high-reflectivity material layers 20, 40 and the first dielectric material layer 30 and the thicknesses of the first dielectric material layer 30, selectivity of wavelength of the transmitting light can be achieved.

In the instant embodiment, the first and second high-reflectivity material layers 20, 40 are each formed of a single-layered silver film having a thickness of 20 nm, between which three fixed spacing distances, which are respectively 200 nm, 345 nm, and 290 nm. In other words, the thicknesses of the first dielectric material layer 30, which is a single-layered silicon dioxide film, at the locations respectively corresponding to the three fixed spacing distances are respectively 200 nm, 345 nm, and 290 nm, which correspond, in sequence, to the wavelengths of blue (426 nm), green (537 nm), and red (618 nm). According to the above formula, a wavelength selection color filter having an average transmissivity greater than 50% for full band can be obtained.

The planarization layer 4 can be a dielectric material layer, such as a metal compound layer, an organic material layer, or a composite material layer, which is a single layer. The arrangement of the planarization layer 4 is to help achieve integration of the TFT array structure layer 6 during the manufacture.

The TFT array structure layer 6 can be formed by directly forming a conventional TFT array structure on the planarization layer 4 and the manufacture can be done through processes of film formation, exposure, development, and etching.

The display structure according to the present invention may comprise a spacer (PS) formed on the TFT array structure layer 6 and then lamination is made to another substrate (not shown) with liquid crystal (not shown) filled therebetween the form a liquid crystal display panel.

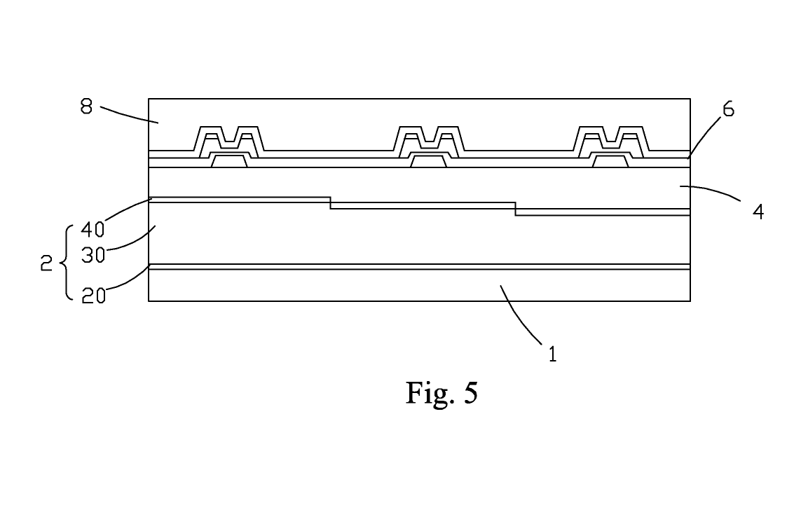

In addition, an OLED (Organic Light Emitting Diode) material can be applied to further improve the first embodiment. Referring to FIG. 5, a second embodiment of the present invention is shown. Compared to the first embodiment, the second embodiment additionally comprises a white-light organic electroluminescence structure layer 8 formed on the TFT array structure layer 6. This makes the display structure of the second embodiment of the present invention a structure of a high-efficiency bottom-lighting full-color OLED display.

In summary, the present invention provides a wavelength selection color filter, which uses the wavelength selection characteristic of a Fabry-Perot structure to achieve a reflective way (not an absorptive way) of light filtering so as to enhance color saturation of the light obtained and improve utilization of light. The display structure of the present invention uses the wavelength selection color filter that includes a Fabry-Perot structure to enhance color saturation of the obtain light and improve the utilization of light, and also enable simultaneous integration of the wavelength selection color filter with a TFT array structure layer on a common substrate, so as to reduce the influence of alignment preciseness and to increase aperture ratio of the display panel to thereby achieve high transmissivity of the display panel.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A wavelength selection color filter, comprising: a first high-reflectivity material layer, a first dielectric material layer formed on the first high-reflectivity material layer, and a second high-reflectivity material layer formed on the first dielectric material layer, the first and second high-reflectivity material layers defining therebetween at least two fixed spacing distances.

2. The wavelength selection color filter as claimed in claim 1, wherein the first and second high-reflectivity material layers are metal material layers, non-metallic material layers, or composite material layers and the first and second high-reflectivity material layers are single-layered structures or multiple-layered structures; and the first dielectric material layer is a metal compound layer, an organic material layer, or a composite material layer and the first dielectric material layer is a single-layered structure.

3. The wavelength selection color filter as claimed in claim 2, wherein the first and second high-reflectivity material layers are single-layered silver films; and the first dielectric material layer is a single-layered silicon dioxide film.

4. The wavelength selection color filter as claimed in claim 3, wherein the single-layered silver films have a thickness of 20 nm and the first and second high-reflectivity material layers define therebetween three fixed spacing distances that are respectively 200 nm, 345 nm, 290 nm.

5. A wavelength selection color filter, comprising: a first high-reflectivity material layer, a first dielectric material layer formed on the first high-reflectivity material layer, and a second high-reflectivity material layer formed on the first dielectric material layer, the first and second high-reflectivity material layers defining therebetween at least two fixed spacing distances;
wherein the first and second high-reflectivity material layers are metal material layers, non-metallic material layers, or composite material layers and the first and second high-reflectivity material layers are single-layered structures or multiple-layered structures; and the first dielectric material layer is a metal compound layer, an organic material layer, or a composite material layer and the first dielectric material layer is a single-layered structure.

6. The wavelength selection color filter as claimed in claim 5, wherein the first and second high-reflectivity material layers are single-layered silver films; and the first dielectric material layer is a single-layered silicon dioxide film.

7. The wavelength selection color filter as claimed in claim 6, wherein the single-layered silver films have a thickness of 20 nm and the first and second high-reflectivity material layers define therebetween three fixed spacing distances that are respectively 200 nm, 345 nm, 290 nm.

8. A display structure, comprising: a substrate, a wavelength selection color filter formed on the substrate, a planarization layer formed on the wavelength selection color filter, and a TFT array structure layer formed on the planarization layer, the wavelength selection color filter comprising: a first high-reflectivity material layer, a first dielectric material layer formed on the first high-reflectivity material layer, and a second high-reflectivity material layer formed on the first dielectric material layer, the first and second high-reflectivity material layers defining therebetween at least two fixed spacing distances.

9. The display structure as claimed in claim 8, wherein the substrate is a glass substrate or a transparent plastic substrate; the planarization layer is a dielectric material layer; and the TFT array structure layer is formed on the planarization layer through processes of film formation, exposure, development, and etching.

10. The display structure as claimed in claim 8, wherein the first and second high-reflectivity material layers are metal material layers, non-metallic material layers, or composite material layers and the first and second high-reflectivity material layers are single-layered structures or multiple-layered structures; and the first dielectric material layer is a metal compound layer, an organic material layer, or a composite material layer and the first dielectric material layer is a single-layered structure.

11. The display structure as claimed in claim 10, wherein the first and second high-reflectivity material layers are single-layered silver films; and the first dielectric material layer is a single-layered silicon dioxide film.

12. The display structure as claimed in claim 11, wherein the single-layered silver films have a thickness of 20 nm and the first and second high-reflectivity material layers define therebetween three fixed spacing distances that are respectively 200 nm, 345 nm, 290 nm.

13. The display structure as claimed in claim 8 further comprising a white-light organic electroluminescence structure layer formed on the TFT array structure layer.
